(19) United States
(12) Patent Application Publication
(10) Pub. No.: US 2011/0306256 A1
(43) Pub. Date: Dec. 15, 2011

(54) CREEP-RESISTANT COMPOSITE STRUCTURES AND PROCESSES FOR THEIR PREPARATION

(75) Inventor: Andri E. Elia, Chadds Ford, PA (US)

(73) Assignee: E. I. DU PONT DE NEMOURS AND COMPANY, Wilmington, DE (US)

(21) Appl. No.: 12/813,535

(22) Filed: Jun. 11, 2010

(51) Int. Cl. B32B 5/02

(52) U.S. Cl. 442/59; 428/221

(57) ABSTRACT

The present invention relates to the field of composite structures comprising a fibrous material, a matrix resin and a portion made of a surface resin composition, wherein the compositions are chosen from compositions comprising one or more thermoplastic resins selected from polyesters, polyamides and mixtures thereof and nanoclays.

### FIELD OF THE INVENTION

The recited invention relates to the field of composite structures and processes for their preparation.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the combination of the fibrous material and the polymer matrix and are used in various end-use applications. Manufacturing techniques have been developed for improving the impregnation of the fibrous material with a polymer matrix to optimize the properties of the composite structure. In highly demanding applications, such as structural parts in automotive and aerospace applications, composite materials are desired due to a unique combination of lightweight, high strength and temperature resistance.

High performance composite structures can be obtained using thermosetting resins or thermoplastic resins as the polymer matrix. Thermoplastic-based composite structures present several advantages over thermoset-based composite structures such as, for example, the fact that they can be post-formed or reprocessed by the application of heat and pressure, that a reduced time is needed to make the composite structures because no curing step is required, and their increased potential for recycling. Indeed, the time consuming chemical reaction of cross-linking for thermosetting resins (curing) is not required during the processing of thermoplastics. Among thermoplastic resins, polyamides and polyesters are particularly well suited for manufacturing composite structures.

Thermoplastic polyamide compositions and thermoplastic polyester compositions are desirable for use in a wide range of applications including motorized vehicles applications; recreation and sport parts; household appliances, electrical/electronic parts; power equipment; and buildings or mechanical devices because of their good mechanical properties, heat resistance, impact resistance and chemical resistance and because they may be conveniently and flexibly molded into a variety of articles of varying degrees of complexity and intricacy.

Examples of composite structures based on thermoplastic polyesters or thermoplastic polyamides are disclosed in U.S. Pat. App. Pub. No. 2008/0176090. The disclosed composite structures are said to have good mechanical properties and smooth surface appearance.

Examples of composite structures based on thermoplastic polyesters are disclosed in U.S. Pat. No. 4,549,920 and U.S. Pat. No. 6,369,157.

U.S. Pat. No. 4,549,920 discloses a fiber-reinforced composite structure made of a thermoplastic polyester, e.g. a polyethylene terephthalate (PET) resin, and reinforcing filaments encased within said resin.

U.S. Pat. No. 6,369,157 discloses a thermoplastic polyester composite structure. The disclosed composite structure is made by impregnating a fibrous material with oligomers of polyesters that rapidly polymerize in situ to form said composite structure.

U.S. Pat. App. Pub. No. 2007/0182047 discloses a method for producing a thermoplastic polyester composite structure. The disclosed method comprises the steps of impregnating a fibrous material with oligomers of polyester, particularly cyclic oligomers of PBT, and coating on one or both sides with an outer layer container a polymerized polyester. The oligomers of polyester rapidly polymerize during the manufacture of the composite structure.

U.S. Pat. No. 5,011,523 discloses a thermoplastic composite made of a commingled fibrous material that is formed from commingled thermoplastic polyester fibers and glass fibers. The fibrous material, i.e. the glass fibers, is impregnated by heat and pressure with the thermoplastic polyester present in the commingled fibrous material.

U.S. Pat. No. 4,255,219 discloses a thermoplastic sheet material useful in forming composites. The disclosed thermoplastic sheet material is made of polyamide 6 and a dibasic carboxylic acid or anhydride or esters thereof and at least one reinforcing mat of long glass fibers encased within said layer. However, composites made from polyamide 6 may show a loss of their mechanical properties over a typical end-use application temperature range, such as for example from a low temperature (e.g. −40° C.) to a high temperature (e.g. +120° C.).

For making integrated composite structures and to increase the performance of polymers, it is often desired to “overmold” one or more parts made of a polymer onto a portion or all of the surfaces of a composite structure so as to surround or encapsulate said surfaces. Overmolding involves shaping, e.g. by injection molding, a second polymer part directly onto at least a portion of one or more surfaces of the composite structure, to form a two-part composite structure, wherein the two parts are adhered one to the other at least at one interface. The polymer compositions used to impregnate the fibrous material (i.e. the matrix polymer composition) and the polymer compositions used to overmold the impregnated fibrous material (i.e. the overmolding polymer composition) are desired to have good adhesion one to the other, extremely good dimensional stability and retain their mechanical properties under adverse conditions, including thermal cycling, so that the composite structure is protected under operating conditions and thus has an increased lifetime. Examples of polyamides that can be used to impregnate a fibrous layer and to overmold the impregnated layer are semi-aromatic polyamides. WO 2007/149300 discloses a semi-aromatic polyamide composite article comprising a component comprising a fiber-reinforced material comprising a polyamide matrix composition, an overmolded component comprising a polyamide composition, and an optional tie layer therebetween, wherein at least one of the polyamide compositions is a semi-aromatic polyamide composition.

Unfortunately, conventional polyamide compositions or polyester compositions that are used to impregnate one or more fibrous reinforcement layers in composite structures and overmolded composite structures may not have sufficient creep-resistance (i.e. tendency to resist to permanent deformation under the influence of stress) may not have sufficient dimensional stability and may have reduced mechanical properties for the most highly demanding applications, all of which may impair the durability and safety of the article upon use and time. An example of a reduced mechanical property that deteriorate upon use and time is the flexural modulus, i.e. the ratio of stress to strain in flexural deformation or the tendency for a material to bend. Flexural modulus is commonly used as an indication of a material's stiffness when flexed. When overmolding a resin composition onto at least a portion of a composite structure, high mechanical performance of the structure may be impaired because of poor bonding strength between the composite structure and the overmolding resin, e. g. in the case of flexural modulus, the interface breaks first because of poor bonding strength, therefore the flex strength of the structure is less than either of its components.

There is a need for a composite structure that combines good creep-resistance and good mechanical properties, especially flexural modulus.

### SUMMARY OF THE INVENTION

It has been surprisingly found that the above mentioned problems can be overcome by composite structures having a surface, which surface has at least a portion made of a surface resin, and comprising a fibrous material selected from non-woven structures, textiles, fibrous battings and combinations thereof, said fibrous material being impregnated with a matrix resin composition, wherein the surface resin composition and the matrix resin composition are identical or different and are chosen from thermoplastic compositions comprising a) one or more thermoplastic resins selected from polyesters, polyamides and mixtures thereof; and b) from at or about 0.5 to at or about 6.0 wt-% of nanoclays, the weight percentages being based on the total weight of the thermoplastic composition.

Also described herein are processes for making the composite structures. The processes for making the composite structure described above comprise a step of i) impregnating with the matrix resin composition the fibrous material, wherein at least a portion of the surface of the composite structure is made of the surface resin composition.

Also described herein are processes for making the composite structures described herein. The process for making the composite structure described herein comprises a step of applying a surface resin composition to a surface of the fibrous material which is impregnated with a matrix resin composition described herein.

Also described herein are uses of from at or about 0.5 to 6.0 wt-%, of nanoclays in thermoplastic compositions comprising a) one or more thermoplastic resins selected from polyesters, polyamides and mixtures thereof described above for improving the flexural strength of a composite structure having a surface, which surface has at least a portion made of a surface resin composition, and comprising a fibrous material selected from non-woven structures, textiles, fibrous battings and combinations thereof, said fibrous material being impregnated with a matrix resin composition, wherein the surface resin composition and the matrix resin composition are identical or different and are chosen from the thermoplastic compositions comprising a) one or more thermoplastic resins selected from polyesters, polyamides and mixtures thereof, the weight percentages being based on the total weight of the thermoplastic composition.

Also described herein are overmolded composite structures comprising:
i) a first component having a surface, which surface has at least a portion made of the surface resin composition, and comprising the fibrous material, said fibrous material being impregnated with the matrix resin composition,
ii) a second component comprising an overmolding resin composition comprising one or more thermoplastic resins,
   wherein the matrix resin and the surface resin composition are identical or different and are chosen from thermoplastic compositions comprising a) one or more thermoplastic resins selected from polyesters, polyamides and mixtures thereof; and b) from at or about 0.5 to at or about 6.0 wt-% of the nanoclays described herein, the weight percentages being based on the total weight of the thermoplastic composition,
and wherein said second component is adhered to said first component over at least a portion of the surface of said first component.

Also described herein are uses of from at or about 0.5 to 6.0 wt-%, of nanoclays in thermoplastic compositions comprising a) one or more thermoplastic resins selected from polyesters, polyamides and mixtures thereof described above for improving the flexural strength of an overmolded composite structure comprising a first component having a surface and a second component of an overmolded composite structure, the weight percentage being based on the total weight of the nanoclay and the one or more thermoplastic resins selected from polyesters, polyamides and mixtures thereof,
wherein the second component is adhered to said first component over at least a portion of the surface of said first component,
wherein the surface of the first component has at least a portion made of a surface resin composition, and comprises a fibrous material selected from non-woven structures, textiles, fibrous battings and combinations thereof such as those described above, said fibrous material being impregnated with a matrix resin composition,
wherein the second component comprises an overmolding resin composition comprising one or more thermoplastic resins, and wherein the matrix resin composition and the surface resin composition are identical or different and are chosen from thermoplastic compositions comprising a) one or more thermoplastic resins selected from polyesters, polyamides and mixtures thereof described above.

Also described herein are processes for making the overmolded composite structures described herein. The process comprises a step of overmolding the composite structure described herein with the overmolding resin composition.

The composite structure and overmolded composite structures according to the present invention exhibit a combination of improved long-term creep performance, improved flexural modulus, i.e. stiffness when flexed, and an increased bonding strength so that the interface between the composite structure and the overmolding resin does not fail early, thereby allowing the structure to realize the bonding strength of its components.

### DETAILED DESCRIPTION

### Definitions

The following definitions are to be used to interpret the meaning of the terms discussed in the description and recited in the claims.

As used herein, the article “a” indicates one as well as more than is one and does not necessarily limit its referent noun to the singular.

As used herein, the terms “about” and “at or about” mean that the amount or value in question may be the value designated or some other value about the same. The phrase is intended to convey that similar values promote equivalent results or effects.

### Composite Structures

The composite structures described herein comprise a fibrous material that is impregnated with a matrix resin composition. At least a portion of the surface of the composite structure is made of a surface resin composition.

Fibrous Material

For purposes herein, “a fibrous material being impregnated with a matrix resin composition” means that the matrix resin composition encapsulates and embeds the fibrous material so as to form an interpenetrating network of fibrous material substantially surrounded by the matrix resin composition. For purposes herein, the term “fiber” is defined as a, macroscopically homogeneous body having a high ratio of length to width across its cross-sectional area perpendicular to its length. The fiber cross section can be any shape, but is typically round.

The fibrous material may be in any suitable form known to those skilled in the art and is preferably selected from non-woven structures, textiles, fibrous battings and combinations thereof. Non-woven structures can be selected from random fiber orientation or aligned fibrous structures. Examples of random fiber orientation include without limitation chopped and continuous material which can be in the form of a mat, a needled mat or a felt. Examples of aligned fibrous structures include without limitation unidirectional fiber strands, bidirectional strands, multidirectional strands, multi-axial textiles. Textiles can be selected from woven forms, knits, braids and combination thereof.

The fibrous material can be continuous or discontinuous in form. Depending on the end-use application of the composite structure and the required mechanical properties, more than one fibrous materials can be used, either by using several same fibrous materials or a combination of different fibrous materials, i.e. the composite structure described herein may comprise one or more fibrous materials. An example of a combination of different fibrous materials is a combination comprising a non-woven structure such as for example a planar random mat which is placed as a central layer and one or more woven continuous fibrous materials that are placed as outside layers. Such a combination allows an improvement of the processing and thereof of the homogeneity of the composite structure thus leading to improved mechanical properties. The fibrous material may be made of any suitable material or a mixture of materials provided that the material or the mixture of materials withstand the processing conditions used during impregnation by the matrix resin composition and the polyamide surface resin composition.

Preferably, the fibrous material is made of glass fibers, carbon fibers, aramid fibers, graphite fibers, metal fibers, ceramic fibers, natural fibers or mixtures thereof; more preferably, the fibrous material is made of glass fibers, carbon fibers, aramid fibers, natural fibers or mixtures thereof; and still more preferably, the fibrous material is made of glass fibers, carbon fibers and aramid fibers or mixture mixtures thereof. As mentioned above, more than one fibrous materials can be used. A combination of fibrous materials made of different fibers can be used such as for example a composite structure comprising one or more central layers made of glass fibers or natural fibers and one or more surface layers made of carbon fibers or glass fibers. Preferably, the fibrous material is selected from woven structures, non-woven structures or combinations thereof, wherein said structures are made of glass fibers and wherein the glass fibers are E-glass filaments with a diameter between 8 and 30 μm and preferably with a diameter between 10 to 24 μm.

The fibrous material may be a mixture of a thermoplastic material to and the materials described above, for example the fibrous material may be in the form of commingled or co-woven yarns or a fibrous material impregnated with a powder made of the thermoplastic material that is suited to subsequent processing into woven or non-woven forms, or a mixture for use as a uni-directional material.

Preferably, the ratio between the fibrous material and the polymer materials, i.e. the combination of the matrix resin composition and surface resin composition is at least 30% and more preferably between 40 and 60%, the percentage being a volume-percentage based on the total volume of the composite structure.

### Matrix Resin Compositions and Surface Resin Compositions

The matrix resin composition and the surface resin composition are identical or different and are chosen from thermoplastic compositions comprising a) one or more thermoplastic resins independently selected from polyesters, polyamides and mixtures thereof; and b) from at or about 0.5 to at or about 6.0 wt-% of nanoclays, the weight percentages being based on the total weight of the thermoplastic composition. Depending on the end-use applications and the desired creep performance and mechanical properties, the one or more thermoplastic resins comprised in the thermoplastic compositions described herein are selected from polyesters, aliphatic polyamides, semi-aromatic polyamides and mixtures thereof.

Thermoplastic polyesters are typically derived from one or more dicarboxylic acids (where herein the term “dicarboxylic acid” also refers to dicarboxylic acid derivatives such as esters) and diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 1 to about 40, Note that (II) and (III) may be a mixture of compounds in which m and z, respectively, may vary and that since m and z are averages, they do not have to be integers. Other dicarboxylic acids that may be used to form the thermoplastic polyester include sebacic and adipic acids. Hydroxycarboxylic acids such as hydroxybenzoic acid may be used as comonomers. Examples of thermoplastic polyesters that can be comprised in the compositions described herein include without limitation selected from poly(ethylene terephthalate) (PET), poly(trimethylene terephthalate) (PTT), poly(1,4-butylene terephthalate) (PBT), poly(ethylene 2,6-naphthoate) (PEN), poly(1,4-cyclohexyldimethylene terephthalate) (PCT) and copolymers and blends of the same.

Polyamides are condensation products of one or more dicarboxylic acids and one or more diamines, and/or one or more aminocarboxylic acids, and/or ring-opening polymerization products of one or more cyclic lactams. The one or more polyamides are preferably selected from fully aliphatic polyamides, semi-aromatic polyamides and blends of the same, semi-aromatic polyamides being preferred.

The term “semi-aromatic” describes polyamides that comprise at least some monomers containing aromatic groups, in comparison with “fully aliphatic” polyamide which describes polyamides comprising aliphatic carboxylic acid monomer(s) and aliphatic diamine monomer(s).

Semi-aromatic polyamides may be derived from one or more aliphatic carboxylic acid components and aromatic diamine components such as for example m-xylylenediamine and p-xylylenediamine, may derived be from one or more aromatic carboxylic acid components and one or more diamine components or may be derived from carboxylic acid components and diamine components.

Preferably, semi-aromatic polyamides are formed from one or more aromatic carboxylic acid components and one or more diamine components. The one or more aromatic carboxylic acids can be terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid, wherein the carboxylic acid component contains at least 55 mole-% of terephthalic acid (the mole-% being based on the carboxylic acid mixture). Preferably, the one or more aromatic carboxylic acids are selected from terephthalic acid, isophthalic acid and mixtures thereof and more preferably, the one or more carboxylic acids are mixtures of terephthalic acid and isophthalic acid, wherein the mixture contains at least 55 mole-% of terephthalic acid. More preferably, the one or more carboxylic acids is 100% terephthalic acid. Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably the mixture of terephthalic acid and adipic acid comprised in the one or more carboxylic acids mixtures of the semi-aromatic polyamide contains at least 55 mole-% of terephthalic acid. one or more semi-aromatic polyamides described herein comprises one or more diamines that can be chosen among diamines having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethyihexamethylene diamine, bis(p-aminocyclohexyl)methane; and/or mixtures thereof. Preferably, the one or more diamines of the semi-aromatic polyamides described herein are selected from hexamethylene diamine, 2-methyl pentamethylene diamine and mixtures thereof, and more preferably the one or more diamines of the semi-aromatic polyamides described herein are selected from hexamethylene diamine and mixtures of hexamethylene diamine and 2-methyl pentamethylene diamine wherein the mixture contains at least 50 mole-% of hexamethylene diamine (the mole-% being based on the diamines mixture). Examples of semi-aromatic polyamides useful in the compositions described herein are commercially available under the trademark Zytel® HTN from E. I. du Pont de Nemours and Company, Wilmington, Del.

Fully aliphatic polyamides are homopolymers, copolymers, or terpolymers formed from aliphatic and alicyclic monomers such as diamines, dicarboxylic acids, lactams, aminocarboxylic acids, and their reactive equivalents. Fully aliphatic polyamides preferably consist of aliphatic repeat units derived from monomers selected from one or more of the group consisting of:
i) aliphatic dicarboxylic acids having 6 to 20 carbon atoms and aliphatic diamines having 4 to 20 carbon atoms; and
ii) lactams and/or aminocarboxylic acids having 4 to 20 carbon atoms.

As used herein, the term “fully aliphatic polyamide” also refers to copolymers derived from two or more of such monomers and blends of two or more fully aliphatic polyamides.

Suitable aliphatic dicarboxylic acids having 6 to 20 carbon atoms include adipic acid (C6), pimelic acid (C7), suberic acid (C8), azelaic acid (C9), decanedioic acid (C10), undecanedioic acid (C11), dodecanedioic acid (C12), tridecanedioic acid (C13), tetradecanedioic acid (C14), and pentadecanedioic acid (C15), hexadecanoic acid (C16), octadecanoic acid (C18) and eicosanoic acid (C20).

Suitable aliphatic diamines having 4 to 20 carbon atoms include tetramethylene diamine, hexamethylene diamine, octamethylene diamine, nonamethylenediamine, decamethylene diamine, dodecamethylene diamine, 2-methylpentamethylene diamine, 2-ethyltetramethylene diamine,2-methyloctamethylenediamine, trimethylhexamethylenediamine, and bis(p-aminocyclohexyl)methane.

Suitable lactams are caprolactam and laurolactam.

Preferred fully aliphatic polyamides include PA46, PA6; PA66; PA610; PA612; PA613; PA614; PA 615; PA616; PA10; PA11; PA 12; PA1010; PA1012; PA1013; PA1014; PA1210; PA1212; PA1213; 1214 and copolymers and blends of the same. More preferred examples of fully aliphatic polyamides in the matrix resin composition and/or surface resin composition and/or overmolding resin composition described herein are PA66 (poly(hexamethylene adipamide), PA612 (poly(hexamethylene dodecanoamide) and blends of the same and are commercially available under the trademark Zytel® from E. I. du Pont de Nemours and Company, Wilmington, Del.

In repeat units comprising a diamine and a dicarboxylic acid, the to diamine is designated first. Repeat units derived from other amino acids or lactams are designated as single numbers designating the number of carbon atoms. The following list exemplifies the abbreviations used to identify monomers and repeat units in the polyamides (PA):
HMD hexamethylene diamine (or 6 when used in combination with a diacid)
AA Adipic acid
DMD Decamethylenediamine
DDMD Dodecamethylenediamine
TMD Tetramethylenediamine
46 polymer repeat unit formed from TMD and AA
6 polymer repeat unit formed from E-caprolactam
66 polymer repeat unit formed from HMD and AA
610 polymer repeat unit formed from HMD and decanedioic acid
612 polymer repeat unit formed from HMD and dodecanedioic acid
613 polymer repeat unit formed from HMD and tridecanedioic acid
614 polymer repeat unit formed from HMD and tetradecanedioic acid
615 polymer repeat unit formed from HMD and pentadecanedioic acid
616 polymer repeat unit formed from HMD and hexadecanoic acid
10 polymer repeat unit formed from 10-aminodecanoic acid
1010 polymer repeat unit formed from DMD and decanedioic acid
1012 polymer repeat unit formed from DMD and dodecanedioic acid
1013 polymer repeat unit formed from DMD and tridecanedioic acid
1014 polymer repeat unit formed from DMD and tetradecanedioic acid
11 polymer repeat unit formed from 11-aminoundecanoic acid
12 polymer repeat unit formed from 12-aminododecanoic acid
1210 polymer repeat unit formed from DDMD and decanedioic acid
1212 polymer repeat unit formed from DDMD and dodecanedioic acid
1213 polymer repeat unit formed from DDMD and tridecanedioic acid
1214 polymer repeat unit formed from DDMD and tetradecanedioic acid

### Nanoclays

The thermoplastic compositions described herein comprise from at or about 0.5 to at or about 6.0 wt-%, preferably form at or about 1.0 to at or about 5.0 wt-% of nanoclays, the weight percentages being based on the total weight of the thermoplastic composition. The nanoclays are available in different forms, e.g. as the compound itself or as a concentrate or masterbatch containing relatively high concentrations of nanoclays in a polymer matrix.

Nanoclays may be layered silicates, and preferably aluminum and/or magnesium silicates. The nanoclays may be in the form of fibrils, platelets, or other shapes and have a diameter in the range of at or about 10 to at or about 5000 nm. The layer thickness is less than about 2 nm. The nanoclays may be naturally occurring or synthetically prepared.

Preferred nanoclays are fibrils having number average diameters less than or equal to about 70 nanometers and number average lengths of up to about 1000 nanometers. Preferably, the nanoclays comprised in the thermoplastic compositions described herein are independently selected from sepiolite-type clays, smectite clays such as montmorillonite, hectorite, saponite, beidelllite, nontronite, bentonite or saponite and mixtures thereof. More preferably, the nanoclays comprised in the thermoplastic compositions described herein are sepiolite-type clays

Sepiolite-type clays are layered fibrous materials in which each layer is made up of two sheets of tetrahedral silica units bonded to a central sheet of octahedral units containing magnesium ions (see, e.g., Polymer International, 53, 1060-1065 (2004) and FIGS. 1 and 2 in L. Bokobza et al., Polymer International, 53, 1060-1065 (2004)). As used herein, the term “sepiolite-type clays” includes attapulgite as well as sepiolite itself.

Sepiolite (Mg₄Si₆O₁₅(OH)₂.6(H₂O) is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The α form is known to be long bundles of fibers and the β form is present as amorphous aggregates.

Aftapulgite (also known as palygorskite) is almost structurally and chemically identical to sepiolite except that attapulgite has a slightly smaller unit cell.

Sepiolite-type clays are available in a high purity, unmodified form (also referred as uncoated form); examples of such sepiolite-type clays include Pangel® S-9 sepiolite clays from the Tolsa Group, Spain. Preferably the nanoclay is in the form of a fine particulate, so it may be readily dispersed in the thermoplastic melt.

The sepiolite-type clays used in the thermoplastic compositions described herein may unmodified modified sepiolite-type clays. The term “unmodified” means that the surface of the sepiolite-type clays has not been treated with an organic compound such as an onium compound (for example, to make its surface less polar).

Sepiolite-type clay fibers comprised in the thermoplastic compositions described herein have a width (x) and thickness (y) of less than 50 nm each, and in addition have a length (z). In an embodiment, the sepiolite-type clay is a rheological grade, such as described in European Pat. No. EP0454222 and EP0170299 and marketed under the trademark Pangel® by Tolsa, S. A., Spain. The term “rheological grade” refers to sepiolite-type clay with a specific surface area greater than 120 m²/g (N₂, BET), and typical fiber dimensions: 200 to 2000 nm long, 10-30 nm wide, and 5-10 nm thick. Rheological grade sepiolite-type clays may be obtained from natural sepiolite-type clays by means of special micronization processes that substantially prevent breakage of the sepiolite fibers, such that the sepiolite-type clays disperses easily in water and other polar liquids, and has an external surface with a high degree of irregularity, a high specific surface, preferably greater than 300 m²/g, and a high density of active centers for adsorption. The active centers allow significant hydrogen bonding that provide the rheological grade sepiolite-type clays a high water retaining capacity. The microfibrous nature of the rheological grade sepiolite-type clays makes sepiolite-type clays a material with high porosity and low apparent density. Additionally, rheological grade sepiolite has a very low cationic exchange capacity (10-20 meq/100 g) and the interaction with electrolytes is very weak, which in turn causes rheological grade sepiolite not to be practically affected by the presence of salts in the medium in which it is found, and therefore, it remains stable in a broad pH range.

The above-mentioned qualities of rheological grade sepiolite can also be attributed to rheological grade attapulgite with particle sizes smaller than 40 microns, such as for example the range of ATTAGEL® goods (for example ATTAGEL® 40 and ATTAGEL® 50 attapulgite) manufactured and marketed by BASF, Florhan Park, N.J. 07932, and the MIN-U-GEL range of Floridin Company.

### Additives

The surface resin composition described herein and/or the matrix resin composition may further comprise one or more impact modifiers, one or more heat stabilizers, one or more reinforcing agents, one or more ultraviolet light stabilizers, one or more flame retardant agents or mixtures thereof.

The matrix resin composition and/or the surface resin composition may further comprise one or more heat stabilizers.

The one or more heat stabilizers may be selected from hindered phenol antioxidants, hindered amine antioxidants, phosphorus antioxidants (e.g. phosphite or phosphonite stabilizers), aromatic amine stabilizers, thioesters, phenolic based anti-oxidants, and mixtures of these. When present, the one or more heat stabilizers are present in an amount from at or about 0.1 to at or about 5 weight percent, or preferably from at or about 0.1 to at or about 3 weight percent, or more preferably from at or about 0.1 to at or about 1 weight percent, the weight percent being based on the total weight of the surface resin composition or the matrix resin composition, as the case may be. When the matrix resin composition and/or the surface resin composition comprises one or more polyamides, the one or more heat stabilizers may also be selected from copper salts and/or derivatives thereof such as for example copper halides or copper acetates; divalent manganese salts and/or derivatives thereof and mixtures thereof. Preferably, copper salts are used in combination with halide compounds and/or phosphorus compounds and more preferably copper salts are used in combination with iodide or bromide compounds, and still more preferably, with potassium iodide or potassium bromide. When present, the one or more heat stabilizers selected from copper salts and/or derivatives are present in an amount from at or about 0.1 to at or about 3 wt-%, or preferably from at or about 0.1 to at or about 1 wt-%, or more preferably from at or about 0.1 to at or about 0.7 wt-%, the weight percentage being based on the total weight of the surface resin composition or the matrix resin composition, as the case may be. The addition of the one or more heat stabilizers improves the thermal stability of the composite structure during its manufacture (i.e. a decreased molecular weight reduction) as well as its thermal stability upon use and time. In addition to the improved heat stability, the presence of the one or more heat stabilizers may allow an increase of the temperature that is used during the impregnation of the composite structure thus reducing the melt viscosity of the matrix resin and/or the surface resin composition described herein. As a consequence of a reduced melt viscosity of the matrix resin and/or the surface resin composition, impregnation rate may be increased.

The surface resin composition described herein and/or the matrix resin composition may further comprise one or more reinforcing agents such as glass fibers, glass flakes, carbon fibers, carbon nanotubes, mica, wollastonite, calcium carbonate, talc, calcined clay, kaolin, magnesium sulfate, magnesium silicate, boron nitride, barium sulfate, titanium dioxide, sodium aluminum carbonate, barium ferrite, and potassium titanate. When present, the one or more reinforcing agents are present in an amount from at or about 1 to at or about 60 wt-%, preferably from at or about 1 to at or about 40 wt-%, or more preferably from at or about 1 to at or about 35 wt-%, the weight percentage being based on the total weight of the surface resin composition or the matrix resin composition, as the case may be.

The surface resin composition described herein and/or the matrix resin composition may further comprise one or more ultraviolet light stabilizers such as hindered amine light stabilizers (HALS), carbon black, substituted resorcinols, salicylates, benzotriazoles, and benzophenones.

The surface resin composition described herein and/or the matrix resin composition may further comprise one or more flame retardant agents such as metal oxides (wherein the metal may be aluminum, iron, titanium, manganese, magnesium, zirconium, zinc, molybdenum, cobalt, bismuth, chromium, tin, antimony, nickel, copper and tungsten), metal powders (wherein the metal may be aluminum, iron, titanium, manganese, zinc, molybdenum, cobalt, bismuth, chromium, tin, antimony, nickel, copper and tungsten), metal salts such as zinc borate, zinc metaborate, barium metaborate, zinc carbonate, magnesium carbonate, calcium carbonate and barium carbonate, metal phosphinates (wherein the metal may be aluminum, zinc or calcium), halogenated organic compounds like decabromodiphenyl ether, halogenated polymer such as poly(bromostyrene) and brominated polystyrene, melamine pyrophosphate, melamine cyanurate, melamine polyphosphate, red phosphorus, and the like.

With the aim of increasing the impregnation rate of the fibrous material, the melt viscosity of the surface resin composition and/or may be reduced and especially the melt viscosity of the matrix resin composition. In general, it is an advantage to have a flow rate of material as high as possible to make the most efficient use of the processing machine and thereby reduce costs by increasing the impregnation rate of the fibrous material. For this reason, highly flowable polymer compositions in molten state are of interest. By having a low melt viscosity, highly flowable polymer compositions flow faster and are thus easier to be processed. By reducing the melt viscosity of the polymer composition, the rate of the impregnation step may be shortened thereby increasing the overall manufacturing speed and thus leading to an increased productivity of the manufacture of the composite structures and a decrease of energy consumption associated with a shorter cycle time that is beneficial also for environmental concerns. In addition to the improved throughput, the increased impregnation rates also minimize the thermal degradation of the polymer composition. With the aim of reducing the melt viscosity of the surface resin composition and/or the matrix resin composition, the surface resin composition described herein and/or the matrix resin composition may further comprise one or more rheology modifiers selected from hyperbranched dendrimers and more preferably one or more hyperbranched polyester dendrimers. Preferred examples of hyperbranched dendrimers are those described in U.S. Pat. No. 5,418,301 US 2007/0173617. The use of such dendrimers in thermoplastic resins is disclosed in U.S. Pat. No. 6,225,404, U.S. Pat. No. 6,497,959, U.S. Pat. No. 6,663,966, WO 2003/004546, EP 1424360 and WO 2004/111126. This literature teaches that the addition of hyperbranched dendritic polyester macromolecules to thermoplastic compositions leads to improved rheological and mechanical properties due to the reduction of the melt viscosity of the composition and, therefore, lead to an improved processability of the thermoplastic composition. When present, the one or more hyperbranched dendrimers comprise from at or about 0.05 to at or about 10 wt-%, or more preferably from at or about 0.1 to at or about 5 wt-%, the weight percentage being based on the total weight of the surface resin composition or the matrix resin composition, as the case may be. When the matrix resin composition and/or the surface resin composition comprise one or more polyamides and with the aim of reducing their melt viscosity of so as to improve the impregnation rate of the composite structure, the surface resin composition and/or the matrix resin composition may further comprise one or more molecular chain breaking agents. Examples of molecular chain breaking agents include without limitation aliphatic dicarboxylic acids and aromatic dicarboxylic acids. Specific examples thereof are oxalic acid, malonic acid, succinic acid, adipic acid, azelaic acid, sebacic acid, dodecanedioic acid, isomers of phthalic acid. When present, the one ore more molecular chain breaking agents comprise from at or about 0.05 to at or about 5 wt-%, or more preferably from at or about 0.1 to at or about 3 wt-%, the weight percentage being based on the total weight of the surface resin composition or the matrix resin composition, as the case may be.

The surface resin composition described herein and/or the matrix resin composition may further comprise modifiers and other ingredients, including, without limitation, flow enhancing additives, lubricants, antistatic agents, coloring agents (including dyes, pigments, carbon black, and the like), flame retardants, nucleating agents, crystallization promoting agents and other processing aids known in the polymer compounding art.

Fillers, modifiers and other ingredients described above may be present in the composition in amounts and in forms well known in the art, including in the form of so-called nano-materials where at least one of the dimensions of the particles is in the range of 1 to 1000 nm.

Making the Compositions

Preferably, the surface resin compositions and the matrix resin compositions described herein are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

Depending on the end-use application, the composite structure described herein may have any shape. Preferably, the composite structure described herein is in the form of a sheet structure.

Making the Composite Structures

Also described herein are processes for making the composite structures described above and the composite structures obtained thereof. The processes comprise a step of i) impregnating with the matrix resin composition the fibrous material, wherein at least a portion of the surface of the composite structure is made of the surface resin composition. Preferably, the fibrous material is impregnated with the matrix resin by thermopressing. During thermopressing, the fibrous material, the matrix resin composition and the surface resin composition undergo heat and pressure in order to allow the plastics to melt and penetrate through the fibrous material and, therefore, to impregnate said fibrous material. Typically, thermopressing is made at a pressure between 2 and 100 bars and more preferably between 10 and 40 bars and a temperature which is above the melting point of the matrix resin composition and the polyamide composition, preferably at least about 20° C. above the melting point to enable a proper impregnation. The heating step may be done by a variety of thermal means, including contact heating, radiant gas heating, infra red heating, convection or forced convection air heating or microwave heating. The driving impregnation pressure can be applied by a static process or by a continuous process (also known as dynamic process), a continuous process being preferred. Examples of impregnation processes include without limitation vacuum molding, in-mold coating, cross-die extrusion, pultrusion, wire coating type processes, lamination, stamping, diaphragm forming or press-molding, lamination being preferred. During lamination, heat and pressure are applied to the fibrous material, the matrix resin composition and the surface resin composition through opposing pressured rollers in a heating zone. Examples of lamination techniques include without limitation calendering, flatbed lamination and double-belt press lamination. When lamination is used as the impregnating process, preferably a double-belt press is used for lamination.

The matrix resin composition and the surface resin composition are applied to the fibrous material by conventional means such as for example powder coating, film lamination, extrusion coating or a combination of two or more thereof, provided that the surface resin composition is applied on at least a portion of the surface of the composite structure so as to be accessible if an overmolding resin is applied onto the composite structure.

During a powder coating process, a polymer powder which has been obtained by conventional grinding methods is applied to the fibrous material. The powder may be applied onto the fibrous material by scattering, sprinkling, spraying, thermal or flame spraying, or fluidized bed coating methods. Optionally, the powder coating process may further comprise a step which consists in a post sintering step of the powder on the fibrous material. The matrix resin composition and the surface resin composition are applied to the fibrous material such that at least of portion of surface of the composite structure is made of the polyamide surface resin composition. Subsequently, thermopressing is achieved on the powder coated fibrous material, with an optional preheating of the powdered fibrous material outside of the pressurized zone. During film lamination, one or more films made of the matrix resin composition and one or more films made of the surface resin composition which have been obtained by conventional extrusion methods known in the art such as for example blow film extrusion, cast film extrusion and cast sheet extrusion are applied to the fibrous material. Subsequently, thermopressing is achieved on the assembly comprising the one or more films made of the matrix resin composition and the one or more films made of the surface resin composition and the one or more fibrous materials. In the resulting composite structure, the film resins have penetrated into the fibrous material as a polymer continuum surrounding the fibrous material. During extrusion coating, pellets and/or granulates made of the matrix resin composition and pellets and/or granulates made of the surface resin composition are extruded through one or more flat dies so as to form one or more melt curtains which are then applied onto the fibrous material by laying down the one or more melt curtains.

Also described herein are processes for making the composite structures described herein, wherein the processes comprise a step of applying a surface resin composition to at least a portion of the surface of the fibrous material which is impregnated with a matrix resin composition described herein.

Depending on the end-use application, the composite structure obtained under the impregnating step i) may be shaped into a desired geometry or configuration, or used in sheet form. The process for making a composite structure described herein may further comprise a step ii) of shaping the composite structure, said step arising after the impregnating step i). The step of shaping the composite structure obtained under step i) may be done by compression molding, stamping or any technique using heat and pressure. Preferably, pressure is applied by using a hydraulic molding press. During compression molding or stamping, the composite structure is preheated to a temperature above the melt temperature of the surface resin composition and is transferred to a forming means such as a molding press containing a mold having a cavity of the shape of the final desired geometry whereby it is shaped into a desired configuration and is thereafter removed from the press or the mold after cooling to a temperature below the melt temperature of the surface resin composition.

Overmolded Composite Structures

In another aspect, the present invention relates to overmolded composite structures and processes to make them. The overmolded composite structure according to the present invention comprises at least two components, i.e. a first component and a second component. The first component consists of the composite structure described above and the second component comprises an overmolding resin composition. The overmolded composite structure may comprise more than one first components, i.e. it may comprise more than one composite structures. The overmolding resin composition comprises one or more thermoplastic resins. The overmolding resin composition comprises one or more thermoplastic resins that are compatible with the surface resin composition. Preferably, the overmolding resin composition comprises one or more thermoplastic resins selected from polyesters, polyamides and mixtures thereof such as those described herein for the matrix resin to compositions and the surface resin compositions.

The overmolding resin composition described herein may further comprise one or more impact modifiers, one or more heat stabilizers, one or more oxidative stabilizers, one or more reinforcing agents, one or more ultraviolet light stabilizers, one or more flame retardant agents or mixtures thereof such as those described herein for the surface resin composition and/or the matrix resin composition. When comprised in the overmolding resin compositions, these additives are present in amounts described above for the surface resin composition and/or the matrix resin composition.

The second component is adhered to the first component over at least a portion of the surface of said first component, said portion of the surface being made of the surface resin composition described above. Preferably, the second component is adhered to the first component over at least a portion of the surface of said first component without any additional adhesive, tie layer or adhesive layer. The first component, i.e. the composite structure, may be fully or partially encapsulated by the second component. Preferably, the first component, i.e. the composite structure described above, is in the form of a sheet structure.

The overmolding resin compositions described herein are preferably melt-mixed blends, wherein all of the polymeric components are well-dispersed within each other and all of the non-polymeric ingredients are well-dispersed in and bound by the polymer matrix, such that the blend forms a unified whole. Melt-mixing methods that can be used are described above for the preparation of the polyamide surface resin compositions and the matrix resin compositions.

Making the Overmolded Composite Structures

In another aspect, the present invention relates to a process for making the overmolded composite structures described above and the overmolded composite structures obtained thereof. The process for making the overmolded composite structure comprising a step of overmolding the first component, i.e. the composite structure described above, with the overmolding resin composition. By “overmolding”, it is meant that a second component is molded onto at least one portion of the surface of a first component.

The first component, i.e. the composite structure described above, is positioned in a molding station comprising a mold having a cavity defining the greater portion of the outer surface configuration of the final overmolded composite structure. The overmolding resin composition may be overmolded on one side or on both sides of the composite structure and it may fully or partially encapsulate the first component. After having positioned the first component in the molding station, the overmolding resin composition is then introduced in a molten form. The first component and the second component are adhered together by overmolding.

The overmolding process includes that the second component is molded in a mold already containing the first component, the latter having been manufactured beforehand as described above, so that first and second components are adhered to each other over at least a portion of the surface of said first component. The at least two parts are preferably adhered together by injection or compression molding as an overmolding step, and more preferably by injection molding. When the overmolding resin composition is introduced in a molten form in the molding station so as to be in contact with the first component, at least a thin layer of an element of the first component is melted and becomes intermixed with the overmolding resin composition.

Depending on the end-use application, the first component, i.e. the composite structure may be shaped into a desired geometry or configuration prior to the step of overmolding the overmolding resin composition. As mentioned above, the step of shaping the composite structure may done by compression molding, stamping or any technique using heat and pressure, compression molding and stamping being preferred. During stamping, the composite structure is preheated to a temperature above the melt temperature of the polyamide surface resin composition and is transferred to a stamping press or a mold having a cavity of the shape of the final desired geometry and it is then stamped into a desired configuration and is thereafter removed from the press or the mold. With the aim of improving the adhesion between the overmolding resin and the polyamide surface resin composition, the surface of the composite structure may be a textured surface so as to increase the relative surface available for overmolding. Such textured surface may be obtained during the step of shaping by using a press or a mold having for example porosities or indentations on its surface.

Alternatively, a one step process comprising the steps of shaping and overmolding the first component in a single molding station may be used. This one step process avoids the step of compression molding or stamping the first component in a mold or a press, avoids the optional preheating step and the transfer of the preheated first component to the molding station. During this one step process, the first component, i.e. the composite structure, is heated outside, adjacent to or within the molding station, to a temperature at which the first component is conformable or shapable during the overmolding step, and preferably it is heated to a temperature below the melt temperature of the composite structure. In such a one step process, the molding station comprises a mold having a cavity of the shape of the final desired geometry. The shape of the first component is thereby obtained during overmolding.

Also described herein are uses of from at or about 0.5 to 6.0 wt-%, of the nanoclays described above in thermoplastic compositions comprising a) one or more thermoplastic resins selected from polyesters, polyamides and mixtures thereof described above for improving the flexural strength of a composite structure having a surface, which surface has at least a portion made of a surface resin composition, and comprising a fibrous material selected from non-woven structures, textiles, fibrous battings and combinations thereof, said fibrous material being impregnated with a matrix resin composition, wherein the surface resin composition and the matrix resin composition are identical or different and are chosen from the thermoplastic compositions comprising a) one or more thermoplastic resins selected from polyesters, polyamides and mixtures thereof, the weight percentages being based on the total weight of the thermoplastic composition.

Also described herein are uses of from at or about 0.5 to 6.0 wt-%, of the nanoclays described above in thermoplastic compositions comprising a) one or more thermoplastic resins selected from polyesters, polyamides and mixtures thereof described above for improving the flexural strength of an overmolded composite structure comprising a first component having a surface and a second component of an overmolded composite structure, the weight percentage being based on the total weight of the nanoclay and the one or more thermoplastic resins selected from polyesters, polyamides and mixtures thereof,
wherein the second component is adhered to said first component over at least a portion of the surface of said first component,
wherein the surface of the first component has at least a portion made of a surface resin composition, and comprises a fibrous material selected from non-woven structures, textiles, fibrous battings and combinations thereof such as those described above, said fibrous material being impregnated with a matrix resin composition,
wherein the second component comprises an overmolding resin composition comprising one or more thermoplastic resins, and wherein the matrix resin composition and the surface resin composition are identical or different and are chosen from thermoplastic compositions comprising a) one or more thermoplastic resins selected from polyesters, polyamides and mixtures thereof described above.

Articles

The composite structures and the overmolded composite structures described herein may be used in a wide variety of applications such as components for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

Examples of automotive applications include without limitation seating components and seating frames, engine cover brackets, engine cradles, suspension cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as housings for hand held electronic devices, computers.

### EXAMPLES

The following materials were used for preparing the composites structures and overmolded composite structures according to the present invention and comparative examples.

Materials

The materials below make up the compositions used in the Examples and Comparative Examples

Semi-aromatic polyamide 1 (PA1): polyamide (PA) made of terephthalic acid and 1,6-hexamethylenediamine (HMD) and 2-methylpentamethylenediamine (MPMD) (HMD:MPMD=50:50) and having a melting point of about 305-315° C. This semi-aromatic polyamide is commercially available from E. I. du Pont de Nemours.

Overmolding resin composition: a composition comprising 50 wt-% of long glass fibers and comprising the semi-aromatic PA1. This composition is commercially available from E. I. du Pont de Nemours.

Nanoclay: a nanodispersed sepiolite supplied by Tolsa, Spain under the trademark Pangel® S9.

Preparation of Films

Compositions comprising a blend of 97 wt-% of the semi-aromatic polyamide PA1 and 3 wt-% of nanoclays were prepared by melt blending a mixture of the two ingredients in a ZSK 30 mm twin-screw extruder equipped with a vacuum port for devolatilization.

Films having a thickness of about 10 mil (254 microns) and made of the compositions listed in Table 1 were prepared by melting the semi-aromatic polyamide PA1 or the semi-aromatic polyamide PA1 comprising the nanoclays in a ZSK 28 mm twin-screw extruder equipped with a film die and a casting drum. The films were processed with a melt temperature of about 337° C. and cast at a temperature of about 150° C.

Preparation of the Composite Structures

The composite structures C1 and E1 and the composite structures C1 and E1 used for preparing the overmolding composite structures C3 and E2 were prepared by compression molding a stack of nine layers made of the films obtained as described above alternating with eight layers of woven continuous glass fiber sheets into a 2 mm thick sheet.

Preparation of the Overmolded Composite Structures

The composite structures C1 and E1 were cut into 1.0 in×8 in (2.5 cm×20.3 cm) rectangular bars and preheated to 150° C. for at least 15 minutes, and then placed in a mold cavity of an injection molding machine (125 ton Engel). The mold was electrically heated at 150° C. and fitted with a 1.0 in×8 in× 3/16 in bar cavity with a bar gate. The injection machine was set at 325° C.

The composite structures C1 and E1 were overmolded with the overmolding resin composition (a composition comprising 50 wt-% of long glass fibers and comprising the polyamide (PA) made of terephthalic acid and 1,6-hexamethylenediamine (HMD) and 2-methylpentamethylenediamine (MPMD) (HMD:MPMD=50:50) described above) such that the resulting overmolded composite structures had a thickness of about 0.18 ( 3/16) in (4.5 mm).

Flexural Modulus

The composite structures (C1 and E1) were cut into about 0.5 in×about 5 in (1.3 cm×12.7 cm) rectangular bars (specimen test size as per method iso 178) and flexural modulus was measured without pre-heating. For comparison, a test specimen (C2:C2) of overmolding resin composition (C2) overmolded on itself was prepared. The overmolding resin composition (C2) was injection molded onto parts (specimen test size as per method ISO 178) having the same thickness as those prepared from the composite structures.

The overmolded composite structures (C3 and E2), the overmolding resin parts (C2:C2) and two composite structures (C1 and E1) listed in Table 1 were cut with a water jet into the required geometry (specimen test size as per method ISO 178, e.g. about 0.5 in×about 5 in (1.3 cm×12.7 cm) rectangular bars) for the determination of flexural modulus, and the corresponding test results are shown in Table 3.

Flexural testing was performed according to ISO 178 with a strain rate of 50 mm/min. For the overmolded composite structures C3 and E2, the test specimens were positioned with the composite structure face or with the overmolded composite face up, and these two results from each are reported in Table 3.

Table 3 gives average values obtained from five specimens.

Creep-Resistance

The composite structures (C1 and E1) were prepared as described above and had the same thickness as above. Specimens were cut using a water jet into 13×60 mm bars that were used for accelerated creep testing in a TA Instruments 983 DMA instrument in creep mode under nitrogen purge of 20 mL/min. The bars were first annealed at 200° C. for two hours, then the mid-section of the bar was clamped between jaws of the DMA instrument allowing 10:1 in length to thickness. Length correction was carried at ambient condition using three lengths. A 2000-minute experiment was set up consisting of a series of isothermal steps of 30 minutes temperature equilibration, 15 minutes loading, and 60 minutes recovering without load. The temperature was then increased by 5° C. for a next cycle of the above three isothermal steps of equilibration, loading, and unloading, beginning with a temperature of 25° C. to 220° C. The short-term compliances vs time curves using 25° C. as the reference temperature were then shifted horizontally along the logarithmic time scale till they overlapped. A master compliance curve was thus created, and then used to calculate the percent (%) of strain.

Table 2 gives average values obtained from five specimens. In the Tables, composites and overmolded composites of the Examples are identified as “E” and composites and overmolded composites of the Comparative Examples as “C”.

TABLE 1
Resin compositions used for preparing the composite structures and the overmolded composite structures
according to the present invention (E1 and E2) and comparative examples (C1, C2 and C3)

| | | | | Overmolded | Overmolded |
|---|---|---|---|---|---|
| | Composite structure | Composite structure | Overmolding resin | composite structure | composite structure |
| | C1 | E1 | C2 | C3 | E2 |
| Surface resin | Semi-aromatic PA | Blend of: | — | Semi-aromatic PA | Blend of: |
| Composition | PA1 | 97 wt-% of PA1 | | PA1 | 97 wt-% of PA1 |
| | | 3 wt-% of nanoclay | | | 3 wt-% of nanoclay |
| Matrix resin | Semi-aromatic PA | Blend of: | — | Semi-aromatic PA | Blend of: |
| Composition | PA1 | 97 wt-% of PA1 | | PA1 | 97 wt-% of PA1 |
| | | 3 wt-% of nanoclay | | | 3 wt-% of nanoclay |
| Overmolding resin | — | — | Blend of: | Blend of: | Blend of: |
| Composition | | | 50 wt-% of long glass | 50 wt-% of long glass | 50 wt-% of long glass |
| | | | fibers | fibers | fibers |
| | | | 50 wt-% of PA1 | 50 wt-% of PA1 | 50 wt-% of PA1 |

TABLE 2
Creep-resistance of the composite structure according to
the present invention (E1) and comparative example (C1)

| | | | Composite | Composite |
|---|---|---|---|---|
| Creep-resistance | | | structure | structure |
| % strain | | | C1 | E1 |
| Stress = 5000 psi | 0 | hours | 0.05 | 0.23 |
| T = 25° C. | 100 | hours | 0.27 | 0.24 |
| | 100000 | hours | 0.33 | 0.28 |
| | 1000000 | hours | — | 0.30 |
| Stress = 10000 psi | 0 | hours | 0.51 | 0.45 |
| T = 25° C. | 100 | hours | 0.54 | 0.48 |
| | 100000 | hours | 0.66 | 0.54 |
| | 1000000 | hours | — | 0.59 |
| Stress = 5000 psi | 0 | hours | 0.26 | 0.23 |
| T = 100° C. | 100 | hours | 0.33 | 0.29 |
| | 100000 | hours | 0.43 | 0.38 |
| | 1000000 | hours | — | 0.40 |
| Stress = 10000 psi | 0 | hours | 0.53 | 0.48 |
| T = 100° C. | 100 | hours | 0.66 | 0.59 |
| | 100000 | hours | 0.86 | 0.76 |
| | 1000000 | hours | — | 0.81 |

“0 hours” means an initial strain caused by the applied stress, subsequent strain was due to creep
“—” means that strain could not be measured due to too much creep

TABLE 3
Flexural modulus (GPa) of the composite structures and the overmolded composite structures
according to the present invention (E1 and E2) and comparative examples (C1, C2 and C3)

| | | | | Overmolded | Overmolded |
|---|---|---|---|---|---|
| Flexural | Composite structure | Composite structure | Overmolding resin | composite structure | composite structure |
| Modulus/GPa | C1 | E1 | C2:C2 | C3 | E2 |
| Composite face | 14.4 | 17.3 | — | 7.1 | 17.5 |
| Overmolded | — | — | 15.5 | 5.5 | 13.1 |
| composite face | | | | | |

As shown in Table 2, a comparative composite structure comprising a matrix resin and a surface resin compositions made of a semi-aromatic polyamide (C1) exhibit a lower creep-resistance compared to the composite structure according to the present invention. The comparative composite structure (C1) showed so much deformation after 100000 hours that is was not possible to measure the % strain. In contrast, the incorporation of nanoclays in the matrix resin and in the surface resin compositions of a composite structure strongly improved the creep-resistance of the composite structure of the present invention (E1) in comparison with a composite structure comprising compositions lacking nanoclays.

As shown in Table 3, a comparative composite structure comprising a matrix resin and a surface resin compositions made of a semi-aromatic polyamide (C1) suffered from low flexural modulus. In contrast, the incorporation of nanoclays in the matrix resin and in the surface resin compositions of a composite structure improved the flexural modulus of the composite structure of the present invention (E1) in comparison with a composite structure comprising compositions lacking nanoclays. Indeed, a flexural modulus value of 17.3 GPa was obtained for the composite structure according to the present invention (E1) in comparison with a value of 14.4 GPa for the comparative composite structure (C1). As shown in Table 3, the comparative overmolded composite structure (C3) comprising a matrix resin and a surface resin compositions made of a semi-aromatic polyamide suffered from low flexural modulus. In contrast, the incorporation of nanoclays in the matrix resin and in the surface resin compositions of an overmolded composite structure strongly improved the flexural modulus of the overmolded composite structure of the present invention (E2). Indeed, a flexural modulus value on the overmolded composite face of 13.1 GPa was obtained for the overmolded composite structure according to the present invention (E2) in comparison with a value of 5.5 GPa for the comparative overmolded composite structure (C3). The low value of the flexural modulus may be attributed to the interface breaking at a low value because of low adhesion between the composite structure and the overmolding resin, while a high flexural modulus may be attributed to the interface being strong and not failing before the failure point is reached for one of the composite structure or the overmolding resin.

The composite structures and overmolded composite structures of the present invention (E1-E2) exhibited not only an improved creep-resistance but also strongly improved mechanical properties, especially flexural modulus. Both of which contribute to the durability and safety of the article upon use and time.

What is claimed is:

1. A composite structure having a surface, which surface has at least a portion made of a surface resin composition, and comprising a fibrous material selected from non-woven structures, textiles, fibrous battings and combinations thereof, said fibrous material being impregnated with a matrix resin composition,
wherein the surface resin composition and the matrix resin composition are identical or different and are chosen from thermoplastic compositions comprising a) one or more thermoplastic resins selected from polyesters, polyamides and mixtures thereof; and b) from at or about 0.5 to at or about 6.0 wt-% of nanoclays, the weight percentages being based on the total weight of the thermoplastic composition.

2. The composite structure of claim 1, wherein the fibrous material is made of glass fibers, carbon fibers, aramid fibers, natural fibers or mixtures thereof.

3. The composite structure of claim 2, wherein the fibrous material is made of glass fibers.

4. The composite structure of any preceding claim, wherein the nanoclays are sepiolite-type clays.

5. The composite structure of any preceding claim, wherein the thermoplastic composition comprises a) one or more polyesters.

6. The composite structure of claim 5, wherein the one or more polyesters are selected from poly(ethylene terephthalate) (PET), poly(trimethylene terephthalate) (PTT), poly(1,4-butylene terephthalate) (PBT), poly(ethylene 2,6-naphthoate) (PEN), poly(1,4-cyclohexyldimethylene terephthalate) (PCT) and copolymers and blends of the same.

7. The composite structure of any one of claims 1 to 4, wherein the thermoplastic composition comprises a) one or more polyamides selected from selected fully aliphatic polyamides, semi-aromatic polyamides and blends of the same.

8. The composite structure of claim 7, wherein the one or more polyamides are selected from semi-aromatic polyamides.

9. The composite structure of any preceding claim, wherein the matrix resin composition and/or the surface resin composition further comprise one or more impact modifiers, one or more heat stabilizers, one or more oxidative stabilizers, reinforcing agents, one or more ultraviolet light stabilizers, one or more flame retardant agents, or mixtures thereof.

10. The composite structure of any preceding claim, wherein the matrix resin composition and/or the surface resin further comprise a melt rheology modifier selected from hyperbranched polyester dendrimers.

11. The composite structure of any preceding claim in the form of a sheet structure.

12. The composite structure of any preceding claim in the form of a component for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

13. A process for making a composite structure having a surface, said process comprises a step of:
impregnating with the matrix resin composition recited in claim 1, in anyone of claims 4 to 10, the fibrous material recited in anyone of claims 1 to 3 wherein at least a portion of the surface of the composite structure is made of the surface resin composition recited in claim 1 or in anyone of claims 4 to 10.

14. An overmolded composite structure comprising:
i) a first component having a surface, which surface has at least a portion made of a surface resin composition, and comprising a fibrous material selected from non-woven structures, textiles, fibrous battings and combinations thereof, said fibrous material being impregnated with a matrix resin composition,
ii) a second component comprising an overmolding resin composition comprising one or more thermoplastic resins,
wherein the surface resin composition and the matrix resin composition are identical or different and chosen from the thermoplastic compositions recited in claim 1 or in anyone of claims 4-10, and
wherein said second component is adhered to said first component over at least a portion of the surface of said first component.

15. The overmolded composite structure of claim 14 in the form of a component for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.
